(19) United States
(12) Patent Application Publication
(10) Pub. No.: US 2016/0062479 A1
(43) Pub. Date: Mar. 3, 2016

(54) IMAGE DISPLAY APPARATUS AND METHOD FOR OPERATING THE SAME

(71) Applicant: LG ELECTRONICS INC., Yeongdeungpo-gu, Seoul (KR)

(72) Inventor: Kyung Min LEE, Seoul (KR)

(21) Appl. No.: 14/786,239

(22) PCT Filed: Apr. 23, 2013
(86) PCT No.: PCT/KR2013/003452

§ 371 Date: Oct. 22, 2015

(51) Int. Cl. G06F 3/033; G06F 3/0346; H04N 21/472; G06F 3/0481

(52) U.S. Cl. CPC G06F 3/033; G06F 3/04812; G06F 3/0346; H04N 21/472

(57) ABSTRACT

An image display apparatus and a method for operating the same are disclosed. The method includes displaying a pointer on a display, receiving a signal from a pointing device, calculating display coordinates for displaying the pointer based on the received signal and a scale mode of the pointing device, and moving the pointer to a point having the calculated coordinates and displaying the pointer at the point. The display coordinates of the pointer are calculated so that the pointer moves a different distance in correspondence with a movement distance of the pointing device according to a scale mode of the pointing device.

### TECHNICAL FIELD

The present invention relates to an image display apparatus and a method for operating the same, and more particularly, to an image display apparatus and a method for operating the same, which can increase user convenience.

### BACKGROUND ART

An image display apparatus has a function of displaying images to a user. The user can view a broadcast program on the image display apparatus. The image display apparatus displays a broadcast program selected by the user on a display from among broadcast programs transmitted from broadcasting stations. The recent trend in broadcasting is a worldwide shift from analog broadcasting to digital broadcasting.

As it transmits digital audio and video signals, digital broadcasting offers many advantages over analog broadcasting, such as robustness against noise, less data loss, ease of error correction, and the ability to provide high-definition, clear images. Digital broadcasting also allows interactive viewer services, compared to analog broadcasting.

### DISCLOSURE OF INVENTION

### Technical Problem

Therefore, the present invention has been made in view of the above problems, and it is an object of the present invention to provide an image display apparatus and a method for operating the same.

It is another object of the present invention to provide an image display apparatus and a method for operating the same, which can perform fine adjustment of display of a pointer by differentiating a movement distance of the pointer displayed on a display according to a scale mode of a pointing device.

### Solution to Problem

In accordance with an aspect of the present invention, the above and other objects can be accomplished by the provision of a method for operating an image display apparatus using a pointing device, including displaying a pointer on a display, receiving a signal from the pointing device, calculating display coordinates for displaying the pointer based on the received signal and a scale mode of the pointing device, and moving the pointer to a point having the calculated coordinates and displaying the pointer at the point. The display coordinates of the pointer are calculated so that the pointer moves a different distance in correspondence with a movement distance of the pointing device according to a scale mode of the pointing device.

In accordance with another aspect of the present invention, there is provided an image display apparatus using a pointing device, including a display for displaying a pointer, a user input interface for receiving a signal from the pointing device, and a controller for calculating display coordinates for displaying the pointer based on the received signal and a scale mode of the pointing device, moving the pointer to a point having the calculated coordinates, and displaying the pointer at the point. The controller is configured to calculate the display coordinates of the pointer so that the pointer moves a different distance in correspondence with a movement distance of the pointing device according to a scale mode of the pointing device.

### BRIEF DESCRIPTION OF DRAWINGS

The above and other objects, features and other advantages of the present invention will be more clearly understood from the following detailed description taken in conjunction with the accompanying drawings, in which:

FIG. 1 is a block diagram of an image display apparatus according to an embodiment of the present invention;

FIG. 2 is a block diagram of a controller illustrated in FIG. 1;

FIG. 3 illustrates a method for controlling a remote controller illustrated in FIG. 1;

FIG. 4 is a block diagram of the remote controller illustrated in FIG. 1;

FIG. 5 is a flowchart illustrating a method for operating the image display apparatus according to an embodiment of the present invention; and

FIGS. 6A to 11B are views referred to for describing the method for operating the image display apparatus illustrated in FIG. 5.

### BEST MODE FOR CARRYING OUT THE INVENTION

Embodiments of the present invention will be described below with reference to the attached drawings.

The terms “module” and “unit” used to signify components are used herein to help the understanding of the components and thus they should not be considered as having specific meanings or roles. Accordingly, the terms “module” and “unit” may be used interchangeably.

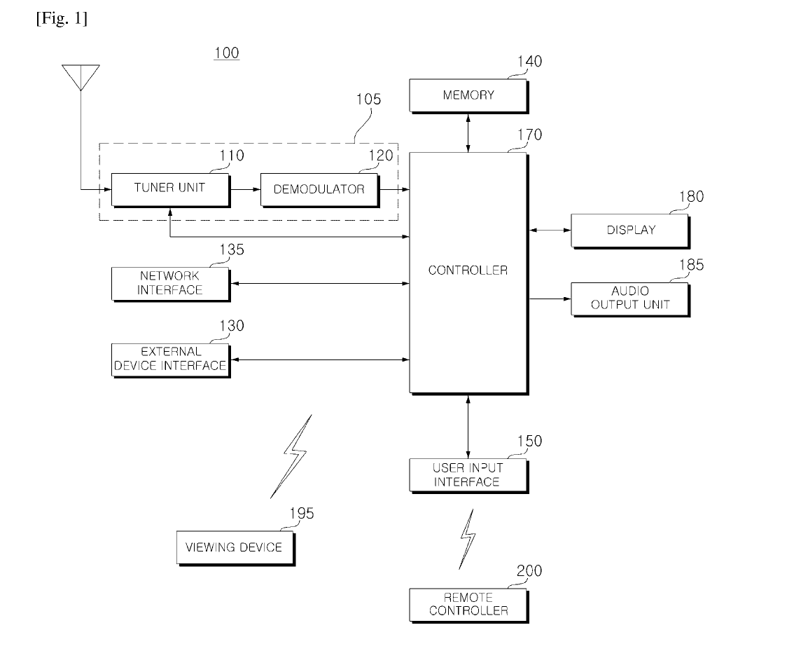

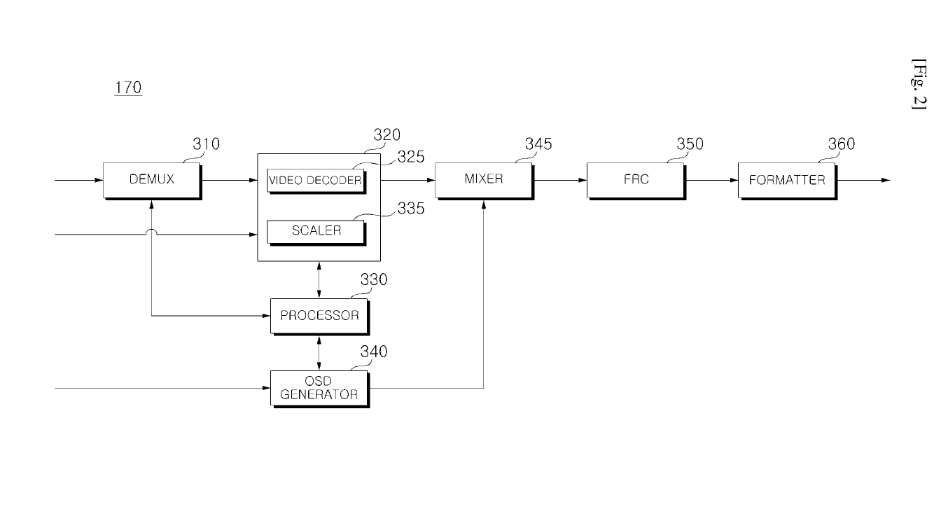

FIG. 1 is a block diagram of an image display apparatus according to an embodiment of the present invention. An image display apparatus 100 according to an embodiment of the present invention may be any of a digital TV, a mobile terminal, a tablet PC, a monitor, a laptop computer, etc.

Referring to FIG. 1, the image display apparatus 100 according to the embodiment of the present invention may include a broadcasting receiver 105, an external device interface 130, a memory 140, a user input interface 150, a sensor unit (not shown), a controller 170, a display 180, an audio output unit 185, and a viewing device 195.

The broadcasting receiver 105 may include a tuner unit 110, a demodulator 120, and a network interface 135. As needed, the broadcasting receiver 105 may be configured so as to include only both the tuner unit 110 and the demodulator 120 or only the network interface 135.

The tuner unit 110 selects a Radio Frequency (RF) broadcast signal corresponding to a channel selected by a user or an RF broadcast signal corresponding to each of pre-stored channels from among a plurality of RF broadcast signals received through an antenna and downconverts the selected RF broadcast signal into a digital Intermediate Frequency (IF) signal or an analog baseband Audio/Video (A/V) signal.

More specifically, if the selected RF broadcast signal is a digital broadcast signal, the tuner unit 110 downconverts the selected RF broadcast signal into a digital IF signal, DIF. On the other hand, if the selected RF broadcast signal is an analog broadcast signal, the tuner unit 110 downconverts the selected RF broadcast signal into an analog baseband A/V signal, CVBS/SIF. That is, the tuner unit 110 may be a hybrid tuner capable of processing not only digital broadcast signals but also analog broadcast signals. The analog baseband A/V signal CVBS/SIF may be directly input to the controller 170.

The tuner unit 110 may be capable of receiving RF broadcast signals from an Advanced Television Systems Committee (ATSC) single-carrier system or from a Digital Video Broadcasting (DVB) multi-carrier system.

The tuner unit 110 may sequentially select a number of RF broadcast signals corresponding to all broadcast channels previously stored in the image display apparatus 100 by a channel add function from a plurality of RF signals received through the antenna and may downconvert the selected RF broadcast signals into IF signals or baseband A/V signals.

The tuner unit 110 may include a plurality of tuners for receiving broadcast signals on a plurality of channels. Alternatively, the tuner unit 110 may be implemented into a single tuner for simultaneously receiving broadcast signals on a plurality of channels.

The demodulator 120 receives the digital IF signal DIF from the tuner unit 110 and demodulates the digital IF signal DIF.

The demodulator 120 may perform demodulation and channel decoding on the digital IF signal DIF, thereby obtaining a stream signal TS. The stream signal TS may be a signal in which a video signal, an audio signal and/or a data signal are multiplexed.

The stream signal TS may be input to the controller 170 and thus subjected to demultiplexing and A/V signal processing. The processed video and audio signals are output to the display 180 and the audio output unit 185, respectively.

The external device interface 130 may transmit data to or receive data from a connected external device. For data transmission and reception, the external device interface 130 may include an A/V Input/Output (I/O) unit (not shown) and/or a wireless communication module (not shown).

The external device interface 130 may be connected to an external device such as a Digital Versatile Disk (DVD) player, a Blu-ray player, a game console, a camera, a camcorder, a computer (e.g. a laptop computer), or a set-top box, wirelessly or by wire. Then, the external device interface 130 may transmit and receive signals to and from the external device.

The A/V I/O unit of the external device interface 130 may receive video and audio signals from the external device. The wireless communication module of the external device interface 130 may perform short-range wireless communication with other electronic devices.

The network interface 135 serves as an interface between the image display apparatus 100 and a wired/wireless network such as the Internet. The network interface 135 may receive content or data from the Internet or from a Content Provider (CP) or a Network Provider (NP) over a network.

The memory 140 may store programs necessary for the controller 170 to process and control signals, and may also store processed video, audio and data signals.

The memory 140 may temporarily store a video, audio and/or data signal received from the external device interface 130. The memory 140 may store information about broadcast channels by the channel-add function such as a channel map.

While the memory 140 is shown in FIG. 1 as configured separately from the controller 170, to which the present invention is not limited, the memory 140 may be incorporated into the controller 170, for example.

The user input interface 150 transmits a signal received from the user to the controller 170 or transmits a signal received from the controller 170 to the user.

For example, the user input interface 150 may receive user input signals such as a power-on/off signal, a channel selection signal, and a screen setting signal from a remote controller 200, provide the controller 170 with user input signals received from local keys (not shown), such as inputs of a power key, a channel key, and a volume key, and a setting key, transmit a user input signal received from the sensor unit (not shown) for sensing a user gesture to the controller 170, or transmit a signal received from the controller 170 to the sensor unit.

The controller 170 may demultiplex the stream signal TS received from the tuner unit 110, the demodulator 120, or the external device interface 130 into a number of signals and process the demultiplexed signals into audio and video data.

The video signal processed by the controller 170 may be displayed as an image on the display 180. The video signal processed by the controller 170 may also be transmitted to an external output device through the external device interface 130.

The audio signal processed by the controller 170 may be output to the audio output unit 185. Also, the audio signal processed by the controller 170 may be transmitted to the external output device through the external device interface 130.

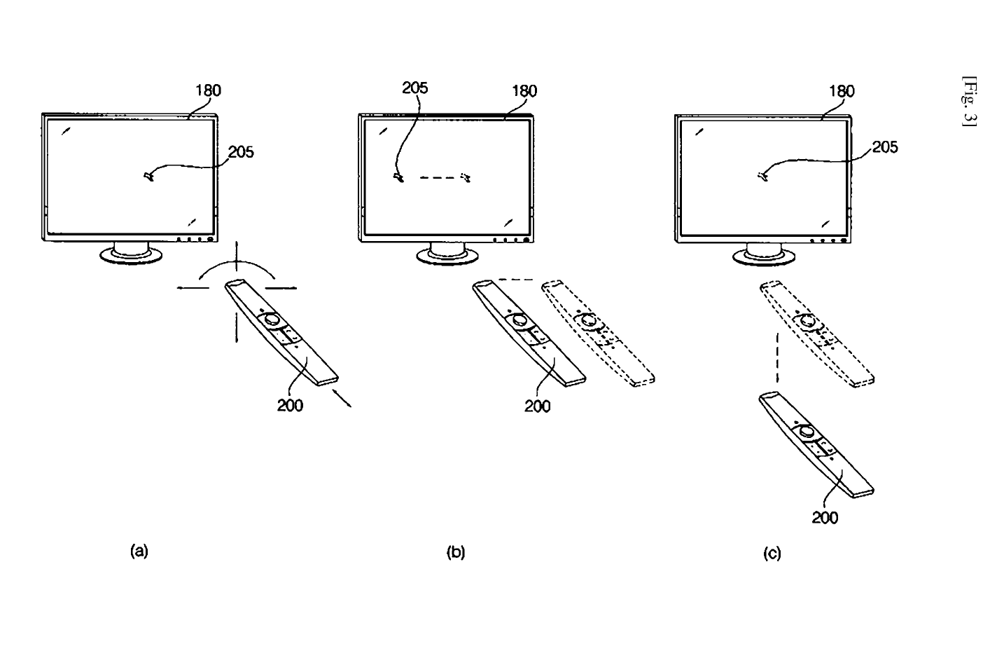

While not shown in FIG. 1, the controller 170 may include a demultiplexer (DEMUX) and a video processor, which will be described later with reference to FIG. 2.

In addition, the controller 170 may provide overall control to the image display apparatus 100. For example, the controller 170 may control the tuner unit 110 to select an RF broadcast signal corresponding to a user-selected channel or a pre-stored channel.

The controller 170 may control the image display apparatus 100 according to a user command received through the user input interface 150 or according to an internal program.

The controller 170 may also control the display 180 to display an image. The image displayed on the display 180 may be a two-dimensional (2D) or three-dimensional (3D) still image or video.

The controller 170 may control a particular object in the image displayed on the display 180 to be rendered as a 3D object. For example, the particular object may be at least one of a linked Web page (e.g. from a newspaper, a magazine, etc.), an Electronic Program Guide (EPG), a menu, a widget, an icon, a still image, a video, or text.

The 3D object may be processed so as to have a different sense of depth from that of an image displayed on the display 180. Preferably, the 3D object may be processed to look protruding, compared to the image displayed on the display 180.

The controller 170 may locate the user based on an image captured by a camera unit (not shown). Specifically, the controller 170 may measure the distance (a z-axis coordinate) between the user and the image display apparatus 100. In addition, the controller 170 may calculate x-axis and y-axis coordinates corresponding to the position of the user on the display 180.

The image display apparatus 100 may further include a channel browsing processor (not shown) for generating thumbnail images corresponding to channel signals or external input signals. The channel browsing processor may extract some of the video frames of each of stream signals TS received from the demodulator 120 or stream signals received from the external device interface 130 and display the extracted video frames on the display 180 as thumbnail images. The thumbnail images may be output to the controller 170 after they are decoded together with a decoded image to a stream. The controller 170 may display a thumbnail list including a plurality of received thumbnail images on the display 180.

The thumbnail list may be displayed on a part of the display 180 with an image displayed on the display 180, that is, as a compact view, or the thumbnail list may be displayed in full screen on the display 180. The thumbnail images of the thumbnail list may be updated sequentially.

The display 180 generates drive signals by converting a processed video signal, a processed data signal, an On Screen Display (OSD) signal, and a control signal received from the controller 170 or a video signal, a data signal, and a control signal received from the external device interface 130.

The display 180 may be various types of displays such as a Plasma Display Panel (PDP), a Liquid Crystal Display (LCD), an Organic Light-Emitting Diode (OLED) display, and a flexible display. The display 180 may also be capable of displaying 3D images.

For 3D visualization, the display 180 may be configured into an auto-stereoscopic 3D display (glasses-free) or a traditional stereoscopic 3D display (with glasses).

Auto-stereoscopy is any method of displaying 3D images without any additional display, for example, special glasses on the part of a user. A lenticular scheme and a parallax barrier scheme are examples of auto-stereoscopic 3D imaging.

The traditional stereoscopy requires an additional display as the viewing device 915 besides the display 180 in order to display 3D images. The additional display may be a Head Mount Display (HMD) type, a glasses type, etc.

As special 3D glasses, polarized glasses operate in a passive manner, whereas shutter glasses operate in an active manner. Also, HMD types may be categorized into passive ones and active ones.

The viewing device 195 may be 3D glasses that enable the user to view 3D images. The 3D glasses 195 may be passive-type polarized glasses, active-type shutter glasses, or an HMD type.

For example, if the viewing device 915 is polarized glasses, the left lens may be configured as a left-eye polarized lens and the right lens may be configured as a right-eye polarized lens.

In another example, if the viewing device 195 is shutter glasses, the left and right lens may be alternately opened and closed.

The display 180 may also be a touch screen that can be used not only as an output device but also as an input device.

The audio output unit 185 may receive a processed audio signal from the controller 170 and output the received audio signal as voice.

The camera unit (not shown) captures a user. The camera unit may include, but not limited to, a single camera. When needed, the camera unit may include a plurality of cameras. The camera unit may be embedded above the display 180 in the image display apparatus 100, or may be separately configured. Image information captured by the camera unit may be provided to the controller 170.

The controller 170 may sense a user's gesture from a captured image received from the camera unit or from signals received from the sensor unit (not shown) alone or in combination.

The remote controller 200 transmits a user input to the user input interface 150. For the transmission of a user input, the remote controller 200 may operate based on various communication standards such as Bluetooth, RF communication, IR communication, Ultra WideBand (UWB), ZigBee, etc. In addition, the remote controller 200 may receive a video signal, an audio signal and/or a data signal from the user input interface 150 and may output the received signal as an image or sound.

The above-described image display apparatus 100 may be a fixed or mobile digital broadcast receiver.

The block diagram of the image display apparatus 100 illustrated in FIG. 1 is an exemplary embodiment of the present invention. The image display apparatus 100 is shown in FIG. 1 as having a number of components in a given configuration. However, the image display apparatus 100 may include fewer components or more components than those shown in FIG. 1 in alternative embodiments. Also, two or more components of the image display apparatus 100 may be combined into a single component or a single component thereof may be separated into two more components in alternative embodiments. The functions of the components of the image display apparatus 100 as set forth herein are illustrative in nature and may be modified, for example, to meet the requirements of a given application.

Unlike the configuration illustrated in FIG. 1, the image display apparatus 100 may be configured so as to receive and playback video content through the network interface 135 or the external device interface 130, without the tuner unit 100 and the demodulator 120.

The image display apparatus 100 is an example of an image signal processing apparatus that processes an input or stored image. In another example, the image display apparatus 100 may be implemented into a set-top box without the display 180 and the audio output unit 185 illustrated in FIG. 1, a DVD player, a Blue-ray player, a game console, a computer, etc.

FIG. 2 is a block diagram of the controller illustrated in FIG. 1.

Referring to FIG. 2, the controller 170 may include a DEMUX 310, a video processor 320, a processor 330, an OSD generator 340, a mixer 345, a Frame Rate Converter (FRC) 350, and a formatter 360 according to an embodiment of the present invention. The controller 170 may further include an audio processor (not shown) and a data processor (not shown).

The DEMUX 310 demultiplexes an input stream. For example, the DEMUX 310 may demultiplex an MPEG-2 TS into a video signal, an audio signal, and a data signal. The input stream signal may be received from the tuner unit 110, the demodulator 120 or the external device interface 130.

The video processor 320 may process the demultiplexed video signal. For video signal processing, the video processor 320 may include a video decoder 325 and a scaler 335.

The video decoder 325 decodes the demultiplexed video signal and the scaler 335 scales the resolution of the decoded video signal so that the video signal can be displayed on the display 180.

The video decoder 325 may be provided with decoders that operate in conformance with various standards.

The decoded video signal processed by the video processor 320 may be a 2D video signal, a 3D video signal, or a combination of both.

For example, it may be determined whether an external video signal received from an external device or a video signal included in a broadcast signal received from the tuner unit 110 is a 2D signal, a 3D signal, or a combination of both. Accordingly, the controller 170, particularly the video processor 320 processes the video signal and outputs a 2D video signal, a 3D video signal, or a combination of both.

The decoded video signal from the video processor 320 may have any of various available formats. For example, the decoded video signal may be a 3D video signal with a color image and a depth image or a 3D video signal including multi-viewpoint image signals. The multi-viewpoint image signals may include, for example, a left-eye image signal and a right-eye image signal.

The processor 330 may provide overall control to the image display apparatus 100 or the controller 170. For example, the processor 330 may control the tuner unit 110 to tune to an RF broadcasting corresponding to a user-selected channel or a pre-stored channel.

The processor 330 may also control the image display apparatus 100 according to a user command received through the user input interface 150 or an internal program.

The processor 330 may control data transmission through the network interface 135 or the external device interface 130.

The processor 330 may control operations of the DEMUX 310, the video processor 320, and the OSD generator 340 in the controller 170.

The OSD generator 340 generates an OSD signal autonomously or according to a user input. For example, the OSD generator 340 may generate signals by which a variety of information is displayed as graphics or text on the display 180, according to user input signals. The OSD signal may include various data such as a User Interface (UI), a variety of menus, widgets, icons, etc. Also, the OSD signal may include a 2D object and/or a 3D object.

Further, the OSD generator 340 may generate a pointer to be displayed on the display 180 based on a pointing signal received from the remote controller 200. Especially, the pointer may be generated from a pointing signal processor (not shown), which may reside in the OSD generator 340. Obviously, the pointing signal processor may be configured separately from the OSD generator 240.

The mixer 345 may mix the decoded video signal processed by the video processor 320 with the OSD signal generated from the OSD generator 340. The OSD signal and the decoded video signal each may include at least one of a 2D signal or a 3D signal. The mixed video signal is provided to the FRC 350.

The FRC 350 may change the frame rate of the mixed video signal or simply output the mixed video signal without frame rate conversion.

The formatter 360 may arrange left-eye and right-eye video frames of the frame rate-converted 3D image. The formatter 360 may also output a synchronization signal Vsync for opening the left and right lenses of the 3D viewing device 195.

The formatter 360 may receive the mixed signal, that is, the OSD signal and the decoded video signal in combination from the mixer 345 and may separate a 2D video signal from a 3D video signal.

Herein, a 3D video signal refers to a signal including a 3D object such as a Picture-In-Picture (PIP) image (a still image or a video), an EPG that describes broadcast programs, a menu, a widget, an icon, text, an object within an image, a person, a background, or a Web page (e.g. from a newspaper, a magazine, etc.).

The audio processor (not shown) of the controller 170 may process the demultiplexed audio signal. For the audio signal processing, the audio processor may have a plurality of decoders.

The audio processor of the controller 170 may also adjust the bass, treble, and volume of the audio signal.

The data processor (not shown) of the controller 170 may process the data signal obtained by demultiplexing the input stream signal. For example, if the demultiplexed data signal is a coded data signal, the data processor may decode the coded data signal. The coded data signal may be an EPG which includes broadcast information specifying the start time, end time, etc. of scheduled broadcast TV or radio programs.

While it is shown in FIG. 2 that the mixer 345 mixes signals received from the OSD generator 340 and the video processor 320 and then the formatter 360 performs 3D processing on the mixed signal, to which the present invention is not limited, the mixer 345 may be positioned after the formatter 360. That is, the formatter 360 may subject an output of the video processor 320 to a 3D process, the OSD generator 340 may generate an OSD signal and perform a 3D process on the OSD signal, and then the mixer 345 may mix the processed 3D signals received from the formatter 360 and the OSD generator 340.

The block diagram of the controller 170 illustrated in FIG. 2 is purely exemplary. Depending upon the specifications of the controller 170 in actual implementation, the components of the controller 170 may be combined or omitted or new components may be added. That is, two or more components are incorporated into one component or one component may be configured as separate components, as needed.

Especially, the FRC 350 and the formatter 360 may be configured separately outside the controller 170.

FIG. 3 illustrates a method for controlling the remote controller illustrated in FIG. 1.

FIG. 3(a) illustrates a pointer 205 representing movement of the remote controller 200, displayed on the display 180.

The user may move or rotate the remote controller 200 up and down, side to side (FIG. 3(b)), and back and forth (FIG. 3(c)). Since the pointer 205 moves in accordance with the movement of the remote controller 200 in a 3D space, the remote controller 200 may be referred to as a 3D pointing device.

Referring to FIG. 3(b), if the user moves the remote controller 200 to the left, the pointer 205 moves to the left on the display 180.

A sensor of the remote controller 200 detects the movement of the remote controller 200 and transmits motion information corresponding to the result of the detection to the image display apparatus. Then, the image display apparatus may determine the movement of the remote controller 200 based on the motion information received from the remote controller 200, and calculate the coordinates of a target point to which the pointer 205 should be shifted in accordance with the movement of the remote controller 200 based on the result of the determination. The image display apparatus then displays the pointer 205 at the calculated coordinates.

Referring to FIG. 3(c), while pressing a predetermined button of the remote controller 200, the user moves the remote controller 200 away from the display 180. Then, a selected area corresponding to the pointer 205 may be zoomed in and enlarged on the display 180. On the contrary, if the user moves the remote controller 200 toward the display 180, the selection area corresponding to the pointer 205 is zoomed out and thus contracted on the display 180. The opposite case is possible. That is, when the remote controller 200 moves away from the display 180, the selection area may be zoomed out and when the remote controller 200 approaches the display 180, the selection area may be zoomed in.

With the predetermined button pressed in the remote controller 200, the up, down, left and right movements of the remote controller 200 may be ignored. That is, when the remote controller 200 moves away from or approaches the display 180, only the back and forth movements of the remote controller 200 are sensed, while the up, down, left and right movements of the remote controller 200 are ignored. Unless the predetermined button is pressed in the remote controller 200, the pointer 205 moves in accordance with the up, down, left or right movement of the remote controller 200.

The speed and direction of the pointer 205 may correspond to the speed and direction of the remote controller 200.

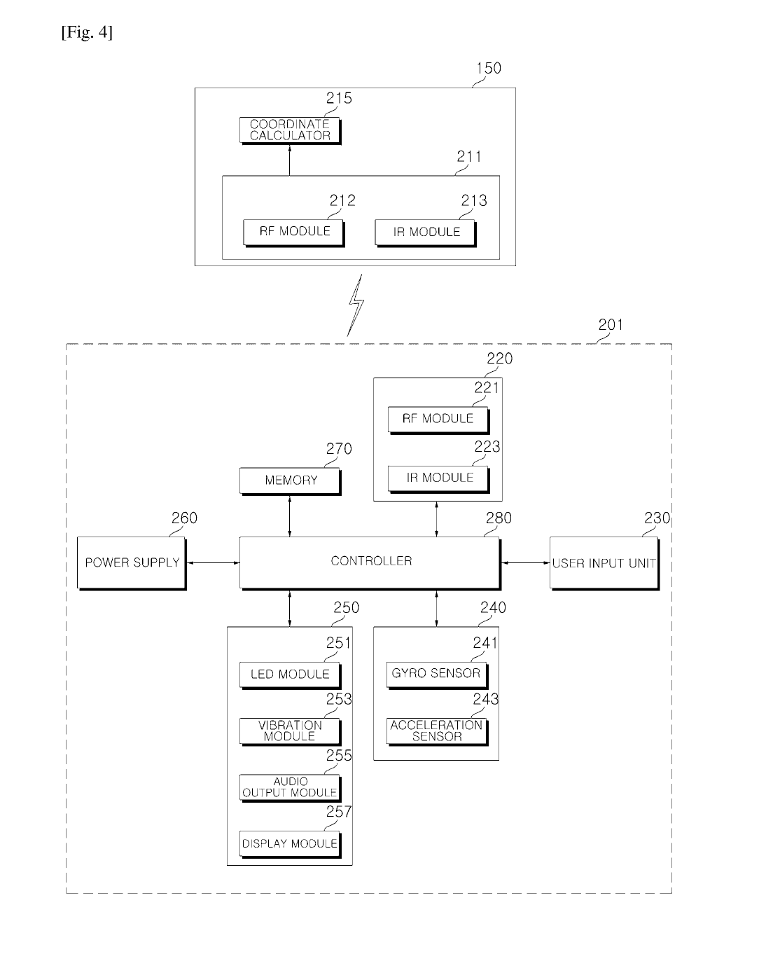

FIG. 4 is a block diagram of the remote controller illustrated in FIG. 1.

Referring to FIG. 4, the remote controller 200 may include a wireless communication module 220, a user input unit 230, a sensor unit 240, an output unit 250, a power supply 260, a memory 270, and a controller 280.

The wireless communication module 220 transmits signals to and/or receives signals from one of image display apparatuses according to embodiments of the present invention. One of the image display apparatuses according to embodiments of the present invention, that is, the image display apparatus 100 will be taken as an example.

In the embodiment of the present invention, the wireless communication module 220 may include an RF module 221 for transmitting RF signals to and/or receiving RF signals from the image display apparatus 100 according to an RF communication standard. The wireless communication module 220 may also include an IR module 223 for transmitting IR signals to and/or receiving IR signals from the image display apparatus 100 according to an IR communication standard.

The remote controller 200 transmits motion information regarding the movement of the remote controller 200 to the image display apparatus 100 through the RF module 221 in the embodiment of the present invention.

The remote controller 200 may also receive signals from the image display apparatus 100 through the RF module 221. The remote controller 200 may transmit commands, such as a power on/off command, a channel switching command, or a sound volume change command, to the image display apparatus 100 through the IR module 223, as needed.

The user input unit 230 may include a keypad, a plurality of buttons, a touch pad, or a touch screen. The user may enter commands to the image display apparatus 100 by manipulating the user input unit 230. If the user input unit 230 includes a plurality of hard-key buttons, the user may input various commands to the image display apparatus 100 by pressing the hard-key buttons. Alternatively or additionally, if the user input unit 230 includes a touch screen displaying a plurality of soft keys, the user may input various commands to the image display apparatus 100 by touching the soft keys. The user input unit 230 may also include various input tools other than those set forth herein, such as a scroll key and/or a jog key, which should not be construed as limiting the present invention.

The sensor unit 240 may include a gyro sensor 241 and/or an acceleration sensor 243. The gyro sensor 241 may sense the movement of the remote controller 200.

For example, the gyro sensor 241 may sense motion information about the remote controller 200 in X-, Y-, and Z-axis directions. The acceleration sensor 243 may sense the moving speed of the remote controller 200. The sensor unit 240 may further include a distance sensor for sensing the distance between the remote controller 200 and the display 180.

The output unit 250 may output a video and/or audio signal corresponding to a manipulation of the user input unit 230 or a signal transmitted by the image display apparatus 100. The user may easily identify whether the user input unit 230 has been manipulated or whether the image display apparatus 100 has been controlled based on the video and/or audio signal output from the output unit 250.

The output unit 250 may include a Light Emitting Diode (LED) module 251 which is turned on or off whenever the user input unit 230 is manipulated or whenever a signal is received from or transmitted to the image display apparatus 100 through the wireless communication module 220, a vibration module 253 which generates vibrations, an audio output module 255 which outputs audio data, and a display module 257 which outputs an image.

The power supply 260 supplies power to the remote controller 200. If the remote controller 200 is kept stationary for a predetermined time or longer, the power supply 260 may, for example, reduce or cut off supply of power to the remote controller 200 in order to save power. The power supply 260 may resume supply of power if a specific key on the remote controller 200 is manipulated.

The memory 270 may store various programs and application data for controlling or operating the remote controller 200. The remote controller 200 may wirelessly transmit signals to and/or receive signals from the image display apparatus 100 in a predetermined frequency band through the RF module 221. The controller 280 of the remote controller 200 may store information regarding the frequency band used for the remote controller 200 to wirelessly transmit signals to and/or wirelessly receive signals from the paired image display apparatus 100 in the memory 270 and may then refer to this information for use at a later time.

The controller 280 provides overall control to the remote controller 200. For example, the controller 280 may transmit a signal corresponding to a key manipulation detected from the user input unit 230 or a signal corresponding to motion of the remote controller 200, as sensed by the sensor unit 240, to the image display apparatus 100 through the wireless communication module 220.

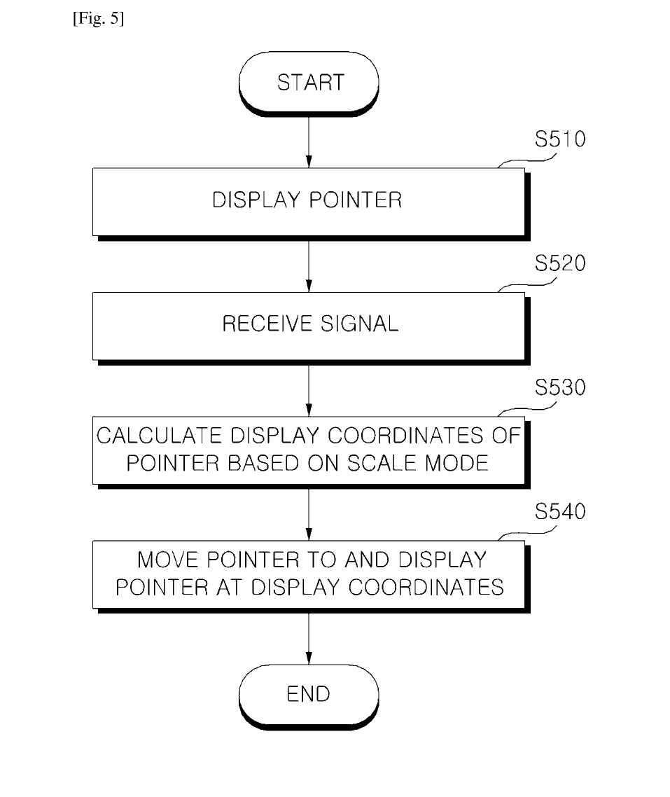

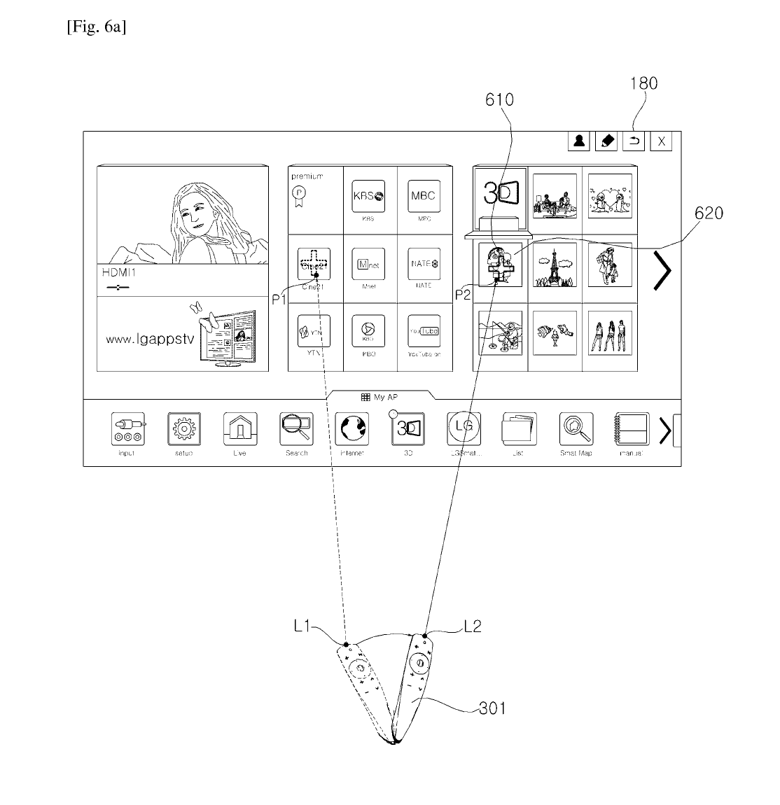

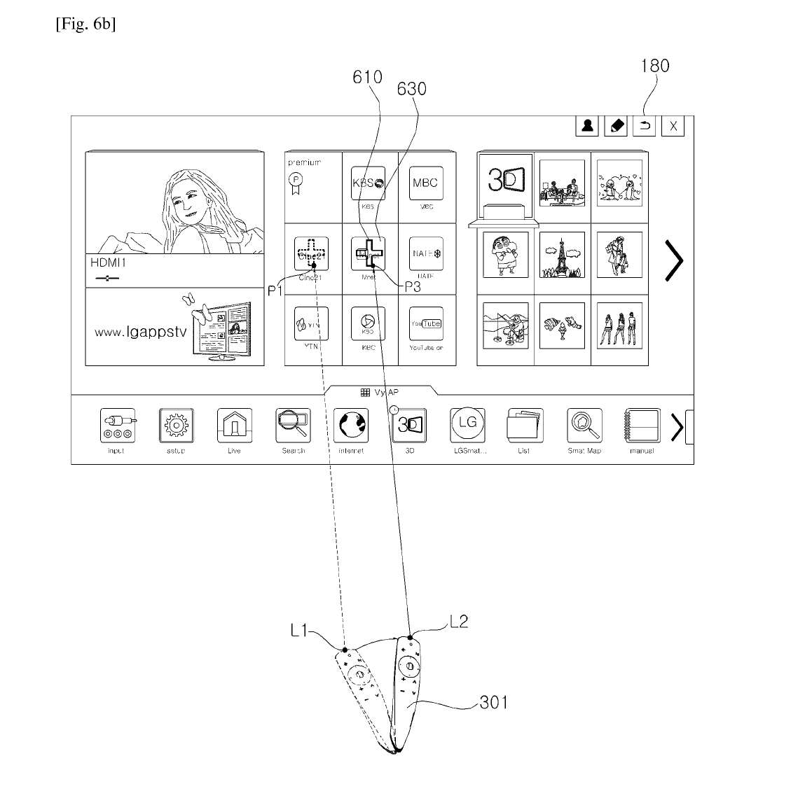

FIG. 5 is a flowchart illustrating a method for operating the image display apparatus according to an embodiment of the present invention, and FIGS. 6A to 11B are views referred to for describing various examples of the method for operating the image display apparatus illustrated in FIG. 5.

Referring to FIG. 5, the image display apparatus 100 displays a pointer on the display 180 (S510).

While a pointer 610 is shown in the form of a cross in FIG. 6, this is purely exemplary and thus does not limit the present invention. Thus, the pointer 610 may be displayed in other forms including an arrow, a cursor, an image, an icon, etc.

The image display apparatus 100 receives a signal from a pointing device 301 (S520) and calculates display coordinates at which the pointer is to be displayed based on the received signal and a scale mode of the pointing device 301 (S530). Then the image display apparatus 100 moves the pointer to the calculated display coordinates and displays the pointer at the calculated display coordinates (S540).

A coordinates calculator 215 of the user input interface 150 or the controller 170 of the image display apparatus 100 may be responsible for calculating the display coordinates of the pointer 610.

In addition, the display coordinates at which the pointer 610 is to be displayed may be different according to the scale mode of the pointing device 301. The display coordinates of the pointer 610 may be calculated in such a manner that the pointer 610 moves a different distance in a different scale mode, in correspondence with the same movement distance of the pointing device 301.

For example, the pointing device 301 may have first and second scale modes. The movement distance of the pointer 610 corresponding to the movement distance of the pointing device 301 may be different in the first and second scale mode.

For the convenience's sake of description, the first scale mode is defined as a large scale mode and the second scale mode is defined as a small scale mode. The pointer moves a longer distance in the first scale mode than in the second scale mode, in correspondence with a movement distance of the pointing device, by way of example.

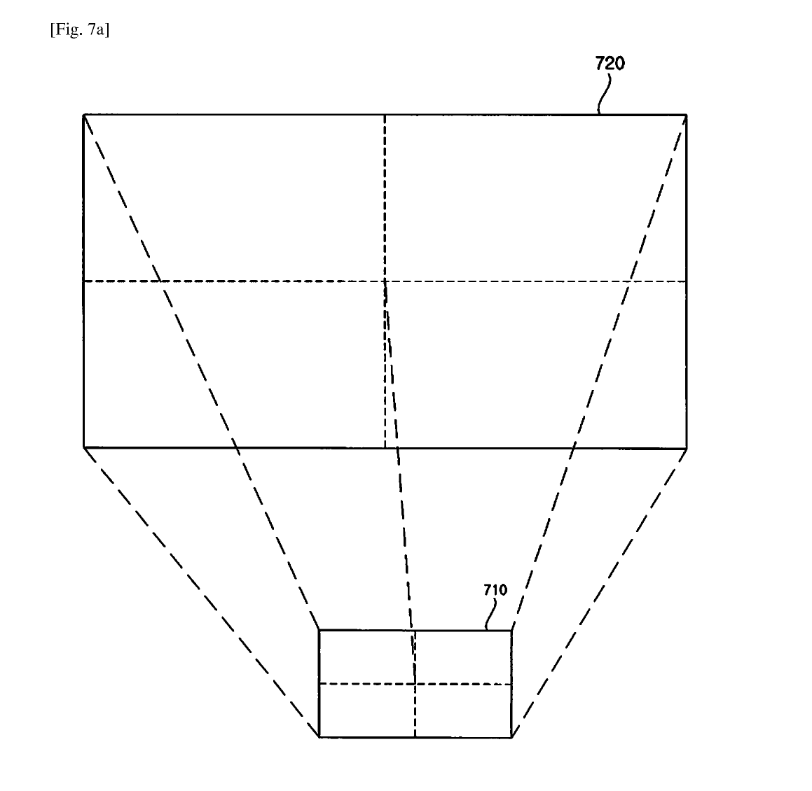

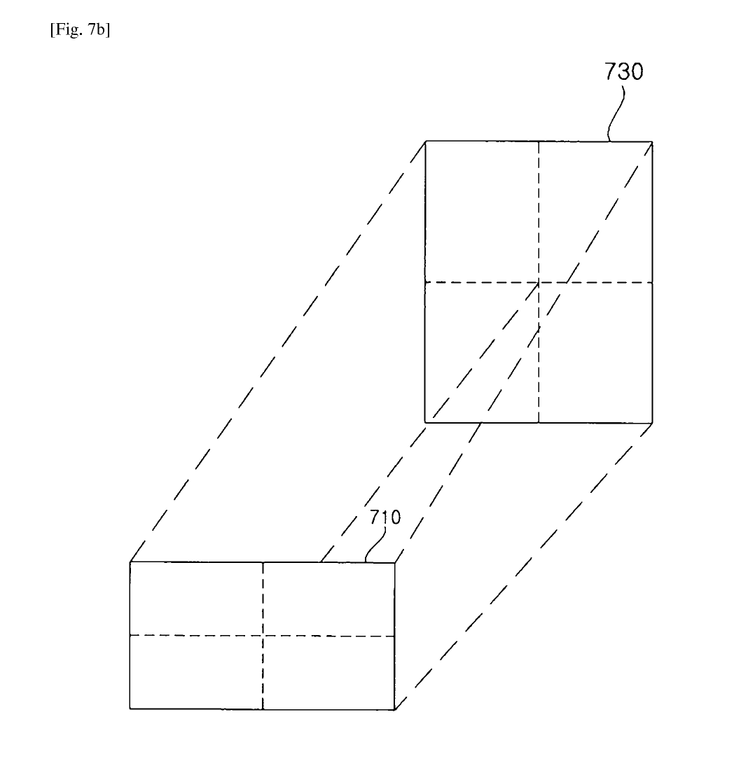

With reference to FIGS. 6A to 7B, the first and second scale modes will be described in detail.

Referring to FIG. 6A, when the pointing device 301 moves from a first point L1 to a second point L2 in the first scale mode, the pointer 610 may move from a first pointer point P1 to a second pointer point P2.

Referring to FIG. 6B, when the pointing device 301 moves from the first point L1 to the second point L2 in the second scale mode, the pointer 610 may move from the first pointer point P1 to a third pointer point P3.

Herein, the display coordinates of the pointer 610 may be calculated in such a manner than the distance between the first and second pointer points P1 and P2 is larger than the distance between the first and third pointer points P1 and P3.

The display coordinates of the pointer 610 may also be calculated in such a manner than the distance between the first and third pointer points P1 and P3 is smaller than the distance between the first and second pointer points P1 and P2.

That is, when the pointer 610 is moved by moving the pointing device 301, the movement distance of the pointer 610 may be different in a different scale mode of the pointing device 301, for the same movement distance of the pointing device 301.

The movement distances of the pointer 610 corresponding to the movement distance of the pointing device 301 may be set for the first and second scale modes by a user input. An actual distance for which the user moves the pointing device 301 may be larger than a movement distance of the pointer 610 displayed on the display 180.

Accordingly, a fine operation may be performed by means of the pointing device 301.

For example, when an object 620 displayed at the second point P2 relatively far from the first point P1 is selected, the object 620 may be readily selected by moving the pointing device 301 in correspondence with a distance for which the pointer 610 is to be moved, as illustrated in FIG. 6A.

On the other hand, when an object 630 displayed at the third point P3 relatively near to the first point P1 is selected, the pointing device 301 should be moved slightly because the pointer 610 is supposed to move a short distance, as illustrated in FIG. 6B.

In this case, since the image display apparatus 100 receives a signal representing a small movement of the pointing device 301 and displays the pointer 610 at a shifted position based on the received signal, the display accuracy of the pointer 610 is decreased and the user cannot move the pointer 610 an intended distance in an intended direction.

Therefore, when the pointer 610 needs fine adjustment as described above, the pointer 610 may be moved by manipulating the pointing device 301 in the second scale mode. As the pointer 610 may be moved slightly through a large movement of the pointing device 301, the user may select the object 630 matching an intended direction and an intended movement distance, even in the case of FIG. 6B.

At least one of the shape, size, or movement speed of the pointer may be different in the first and second scale modes.

For example, the pointer may be shaped into ‘L’ in the first scale mode and ‘S’ in the second scale mode. Alternatively or additionally, the pointer may be displayed larger in the first scale mode than in the second scale mode.

Alternatively or additionally, the pointer may move faster in the first scale mode than in the second scale mode.

In this manner, a scale mode of the pointing device can be readily indicated to a user by differentiating at least one of the shape, size and movement speed of the pointer in the first and second scale modes.

If the pointing device 301 operates in the first scale mode, the pointer 610 may be moved to and displayed on the full area of the display 180.

For example, as illustrated in FIG. 7A, coordinates 710 on the operation plane of the pointing device 301 are translated into coordinates 720 on the full plane of the display 180 in the first scale mode. The pointer 610 may be moved to and displayed at the coordinates 720 on the full plane of the display 180 according to the position coordinates and coordinates variation of the pointing device 301 on the operation plane of the pointing device 301.

On the other hand, when the pointing device 301 operates in the second scale mode, the pointer 610 may be moved to and displayed on a limited specific area of the display 180.

As illustrated in FIG. 7B, for example, the coordinates 710 on the operation plane of the pointing device 301 may be translated into coordinates 730 on a specific area of the display 180 in the second scale mode. The pointer 610 may be moved to and displayed at the coordinates 730 in the specific area of the display 180 according to the position coordinates and coordinates variation of the pointing device 301 on the operation plane of the pointing device 301.

Therefore, fine adjustment of the pointer 610 is possible in the case of translating the coordinates 710 on the operation plane of the pointing device 301 into the coordinates 720 on the entire plane of the display 180 (the first scale mode), compared to the case of translating the coordinates 710 on the operation plane of the pointing device 301 into the coordinates 730 in the specific area of the display 180 (the second scale mode).

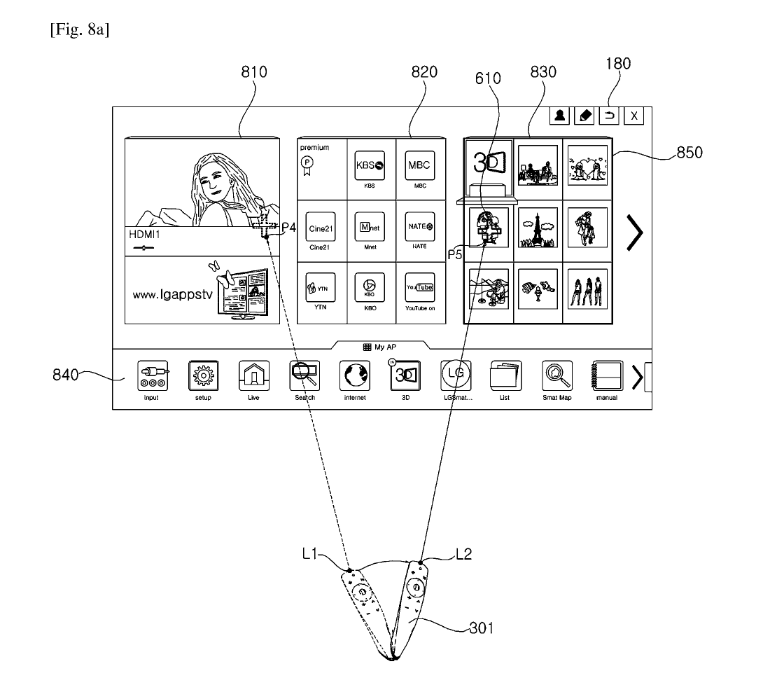

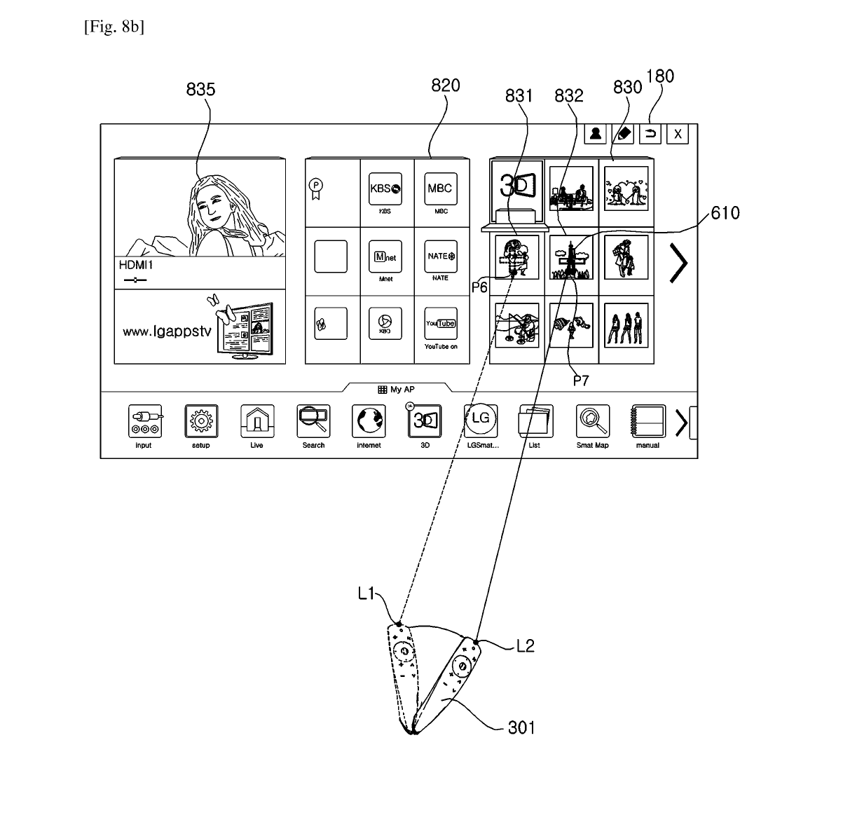

As illustrated in FIG. 8A, for example, when a plurality of higher-layer object menu areas 810 to 840 are displayed on the display 180 and the pointing device 301 operates in the first scale mode, the pointer 610 may be moved to and displayed on the full plane of the display 180 as described before with reference to FIG. 7A. Thus, one of the plurality of higher-layer object menu areas 810 to 840 may be selected by moving the pointer 610.

For example, when the pointing device 301 moves from the first point L1 to the second point L2 in the first scale mode, the pointer 610 may move from a fourth pointer point P4 to a fifth pointer point P5 as illustrated in FIG. 8A. A higher-layer object menu area selected according to the position of the pointer 610 may be indicated by further displaying a square object 850.

Therefore, the first higher-layer object menu area 810 including the fourth pointer point P4 may be selected, or the third higher-layer object menu area 830 including the fifth pointer point P5 may be selected by moving the pointer 610 to the fifth pointer point P5.

After the higher-layer object menu area 830 is selected by operating the pointing device 301 in the first scale mode in the above manner, a lower-layer object may be selected by operating the pointing device 301 in the second scale mode in the selected higher-layer object menu area 830 as illustrated in FIG. 8B.

The pointer 610 may be moved to and displayed only within the selected higher-layer object menu area 830 in a limited manner. As the second scale mode is set, the pointer 610 may be moved and displayed on a point corresponding to a movement distance of the pointing device 301.

A first lower-layer object 831 displayed at a sixth pointer point P6 may be selected, or a second lower-layer object 832 displayed at a seventh pointer point P7 may be selected by moving the pointer 610 to the seventh pointer point P7.

In addition, the specific object menu area 830 available to the pointer 610 may be activated on the display 180, whereas an object area 835 unavailable to the pointer 610 may be deactivated on the display 180.

Meanwhile, when the pointer is displayed in a first area of the display, the pointing device may be switched to the first scale mode, and when the pointer is displayed in a second area of the display, the pointing device may be switched to the second scale mode.

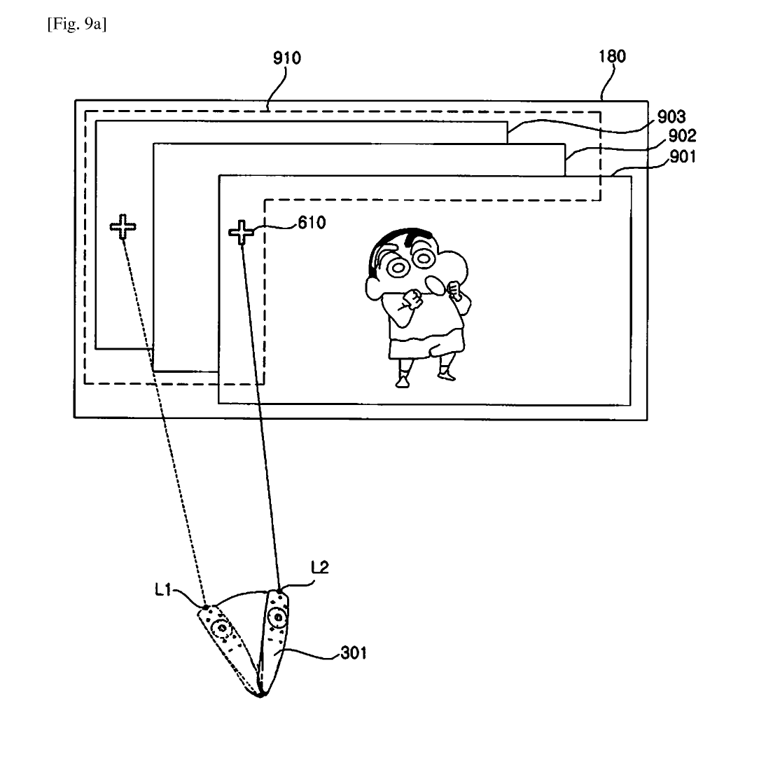

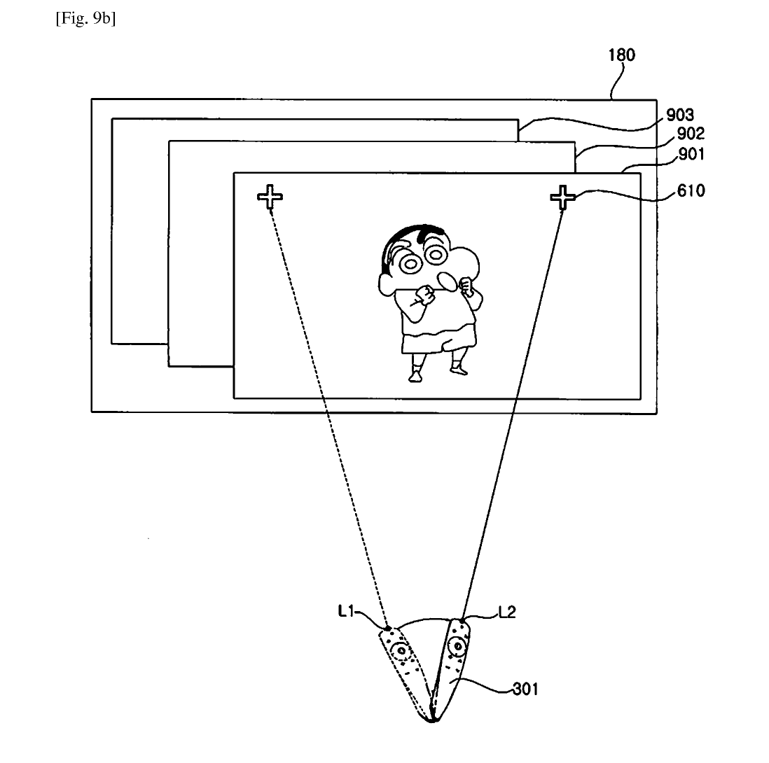

Referring to FIG. 9A, for example, when a plurality of screens 901, 902 and 903 are displayed overlapped with one another on the display 180, one of the plurality of screens 901, 902 and 903 may be selected by moving the pointer 610 in a boundary area 910 of the plurality of screens 901, 902 and 903.

Since the plurality of screens 901, 902 and 903 are overlapped densely with a narrow gap, the user has difficulty in selecting an intended screen by moving the pointer 610 in the boundary area 910.

Hence, when the pointer 610 is displayed in the boundary area 910 of the plurality of screens 901, 902 and 903, the scale mode of the pointing device 301 may be switched to the second scale mode. As the pointing device 301 is placed in the second scale mode, the user may readily select an intended screen through fine adjustment of the pointer 610 in the boundary area 910.

On the other hand, if the pointer 610 is displayed within the first screen 901 as illustrated in FIG. 9B, the pointing device 301 may be switched to the first scale mode.

Therefore, when the pointer 610 is displayed in the boundary area 910 to select one of the plurality of screens 901, 902 and 903, the pointing device 301 operates in the second scale mode, for fine adjustment of the pointer 610. If the screen is selected and the pointer 610 is positioned within the selected screen, the pointing device 301 is automatically switched to the first scale mode and thus operates in the first scale mode.

Further, the pointing device 301 may be switched to one of the first and second scale modes according to the size of an object area on which the pointer 610 is displayed.

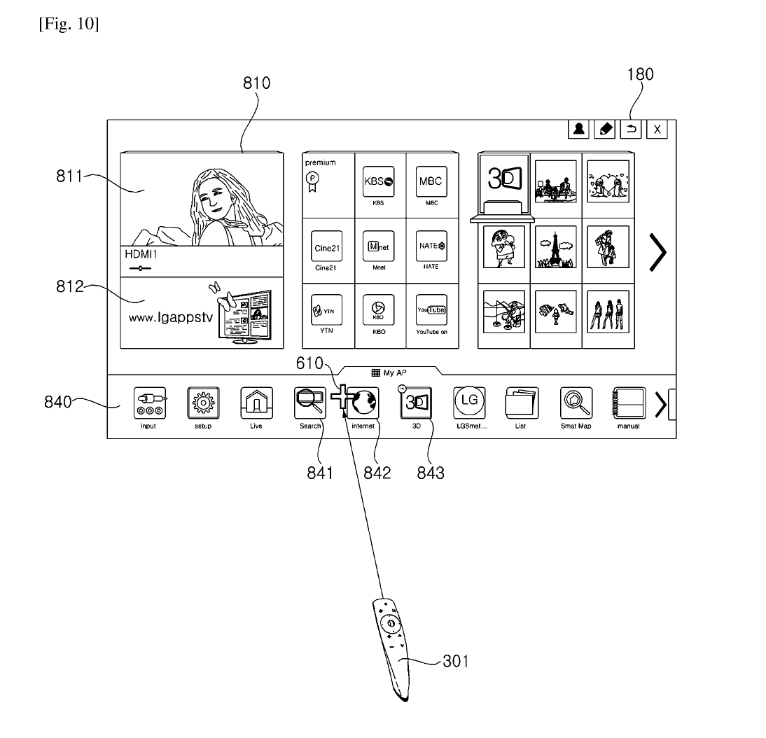

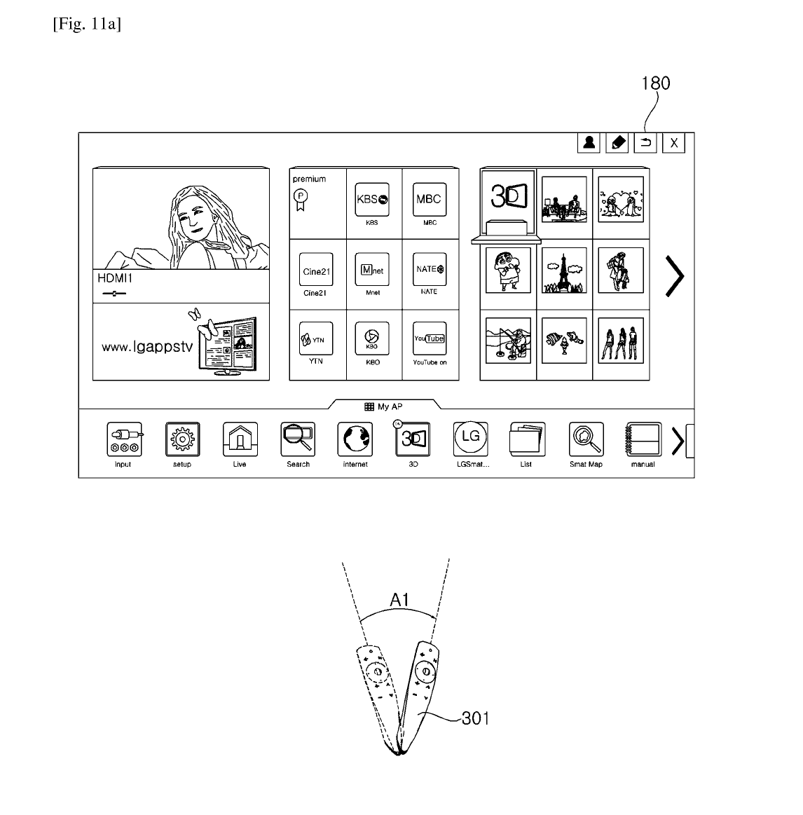

Referring to FIG. 10, for example, if the area of each of a plurality of objects 841, 842 and 843 included in the object menu area 840 in which the pointer 610 is displayed is smaller than a predetermined size, it is difficult for the user to select an intended one of the objects 841, 842 and 843 by moving the pointer 610.

Therefore, if the area of each of a plurality of objects included in the object menu area 840 in which the pointer 610 is displayed is smaller than a predetermined size, the pointing device 301 may be switched to the second scale mode. Fine adjustment of the pointer 610 in the object menu area 840 is possible in the second scale mode and thus the user can readily select an intended object.

In contrast, if the area of each of a plurality of objects 811 and 812 included in the object menu area 810 is equal to or larger than a predetermined size, the pointing device 301 may be switched to the first scale mode. A reference value for an object area may be set by a user input.

Meanwhile, the scale mode of the pointing device may be switched by a user input, irrespective of the characteristics of a display area in which the pointer is displayed.

For example, when the image display apparatus 100 receives a first specific key input, the pointing device 301 may be switched to the first scale mode, whereas when the image display apparatus 100 receives a second specific key input, the pointing device 301 may be switched to the second scale mode.

Accordingly, when fine adjustment is needed for the pointer 610 during movement of the pointer 610 on the display 180 in correspondence with movement of the pointing device 301 in the first scale mode, the user of the image display apparatus 100 may switch the pointing device 301 to the second scale mode by the second specific key input.

The scale mode of the pointing device may be switched by sideways movement of the pointing device.

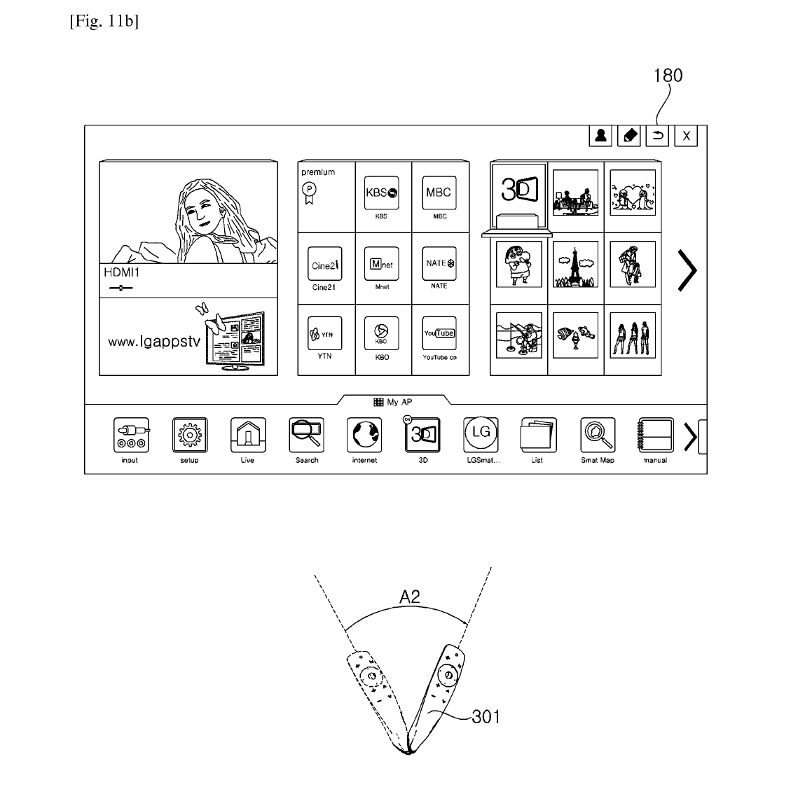

For example, when the user moves the pointing device 301 sideways, the image display apparatus 100 may receive signals from the pointing device 301 and calculate movement angles A1 and A2 of the pointing device 301 based on the received signals in FIGS. 11A and 11B.

If the movement angle A1 of the pointing device 301 is smaller than a predetermined angle, the pointing device 301 may be switched to the first scale mode, as illustrated in FIG. 11A. On the other hand, if the movement angle A2 of the pointing device 301 is equal to or larger than the predetermined angle, the pointing device 301 may be switched to the second scale mode, as illustrated in FIG. 11B.

Or when the pointing device 301 is moved a predetermined distance or longer toward the display 180, the pointing device 301 may be switched to the second scale mode. If the pointing device 301 recedes a predetermined distance or longer from the display 180, the pointing device 301 may be switched to the first scale mode.

In this manner, the user can switch the pointing device 301 to an intended scale mode, thus efficiently using the pointing device 301. Therefore, user convenience can be increased.

As is apparent from the above description of the present invention, since fine adjustment of display of a pointer is possible in correspondence with movement of a pointing device, the pointer can be displayed with an increased accuracy.

The scale mode of the pointing device can be controlled automatically according to the characteristics of a display area of the pointer and can be readily switched in response to a predetermined input, as well.

As a consequence, user convenience can be increased.

The image display apparatus and the method for operating the same according to the foregoing exemplary embodiments are not restricted to the exemplary embodiments set forth herein. Therefore, variations and combinations of the exemplary embodiments set forth herein may fall within the scope of the present invention.

The method for operating an image display apparatus according to the foregoing exemplary embodiments may be implemented as code that can be written on a computer-readable recording medium and thus read by a processor. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission over the Internet). The computer-readable recording medium can be distributed over a plurality of computer systems connected to a network so that computer-readable code is written thereto and executed therefrom in a decentralized manner. Programs, code, and code segments to realize the embodiments herein can be construed by one of ordinary skill in the art.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for operating an image display apparatus using a pointing device, the method comprising:
displaying a pointer on a display;
receiving a signal from the pointing device;
calculating display coordinates for displaying the pointer based on the received signal and a scale mode of the pointing device; and
moving the pointer to a point having the calculated coordinates and displaying the pointer at the point,
wherein the display coordinates of the pointer are calculated so that the pointer moves a different distance in correspondence with a movement distance of the pointing device according to a scale mode of the pointing device.

2. The method according to claim 1, wherein scale modes of the pointing device include a first scale mode and a second scale mode, further comprising switching the scale mode of the pointing device from the first scale mode to the second scale mode or from the second scale mode to the first scale mode.

3. The method according to claim 2, wherein movement distances of the pointer corresponding to a movement distance of the pointing device are set for the first and second scale modes by a user input.

4. The method according to claim 2, wherein for the same movement distance of the pointing device, the pointer moves a larger distance in the first scale mode than in the second scale mode.

5. The method according to claim 2, wherein the pointer moves the same distance as the pointing device in the first scale mode.

6. The method according to claim 2, wherein a displayable area of the pointer is limited to a specific area in the second scale mode.

7. The method according to claim 2, wherein the switching of the scale mode of the pointing device comprises:
receiving a signal representing sideways movement of the pointing device;
switching the pointing device to the first scale mode, if an angle of the sideways movement is smaller than a predetermined angle; and
switching the pointing device to the second scale mode, if the angle of the sideways movement is equal to or larger than the predetermined angle.

8. The method according to claim 2, wherein the switching of the scale mode of the pointing device comprises:
switching the pointing device to the first scale mode, if the pointer is displayed in a first area of the display; and
switching the pointing device to the second scale mode, if the pointer is displayed in a second area of the display.

9. The method according to claim 2, wherein the switching of the scale mode of the pointing device comprises:
switching the pointing device to the first scale mode, upon receipt of a first specific key input; and
switching the pointing device to the second scale mode, upon receipt of a second specific key input.

10. The method according to claim 2, further comprising displaying an object, wherein the pointer is displayed on the object and the switching of the scale mode of the pointing device comprises switching the pointing device to one of the first and second scale modes based on the size of an area of the object.

11. The method according to claim 2, wherein the first and second scale modes differ in one of the shape, size, and movement speed of the pointer.

12. An image display apparatus using a pointing device, comprising:
a display for displaying a pointer;
a user input interface for receiving a signal from the pointing device; and
a controller for calculating display coordinates for displaying the pointer based on the received signal and a scale mode of the pointing device, moving the pointer to a point having the calculated coordinates, and displaying the pointer at the point,
wherein the controller is configured to calculate the display coordinates of the pointer so that the pointer moves a different distance in correspondence with a movement distance of the pointing device according to a scale mode of the pointing device.

13. The image display apparatus according to claim 12, wherein scale modes of the pointing device include a first scale mode and a second scale mode, and the controller switches the scale mode of the pointing device from the first scale mode to the second scale mode or from the second scale mode to the first scale mode.

14. The image display apparatus according to claim 13, wherein movement distances of the pointer corresponding to a movement distance of the pointing device are set for the first and second scale modes by a user input.

15. The image display apparatus according to claim 13, wherein the controller controls the pointer to move a larger distance in the first scale mode than in the second scale mode, for the same movement distance of the pointing device.

16. The image display apparatus according to claim 13, wherein the controller controls the pointer to move the same distance as the pointing device in the first scale mode.

17. The image display apparatus according to claim 13, wherein the controller limits a displayable area of the pointer to a specific area in the second scale mode.

18. The image display apparatus according to claim 13, wherein the controller receives a signal representing sideways movement of the pointing device, switches the pointing device to the first scale mode, if an angle of the sideways movement is smaller than a predetermined angle, and switches the pointing device to the second scale mode, if the angle of the sideways movement is equal to or larger than the predetermined angle.

19. The image display apparatus according to claim 13, wherein if the pointer is displayed in a first area of the display, the controller switches the pointing device to the first scale mode, and if the pointer is displayed in a second area of the display, the controller switches the pointing device to the second scale mode.

20. The image display apparatus according to claim 13, wherein upon receipt of a first specific key input, the controller switches the pointing device to the first scale mode and upon receipt of a second specific key input, the controller switches the pointing device to the second scale mode.

21. The image display apparatus according to claim 13, wherein the controller switches the pointing device to one of the first and second scale modes based on the size of an area of an object on which the pointer is displayed.

22. The image display apparatus according to claim 13, wherein the first and second scale modes differ in one of the shape, size, and movement speed of the pointer.
